(19) United States
(12) Patent Application Publication
(10) Pub. No.: US 2024/0278571 A1
(43) Pub. Date: Aug. 22, 2024

(54) MAINTENANCE APPARATUS, LIQUID DISCHARGE APPARATUS, AND MAINTENANCE METHOD

(71) Applicants: Yusuke NEMOTO, Kanagawa (JP); Yusuke TOKUNAGA, Kanagawa (JP)

(72) Inventors: Yusuke NEMOTO, Kanagawa (JP); Yusuke TOKUNAGA, Kanagawa (JP)

(21) Appl. No.: 18/436,041

(22) Filed: Feb. 8, 2024

(30) Foreign Application Priority Data
Feb. 16, 2023 (JP) 2023-022686
May 31, 2023 (JP) 2023-089960

(51) Int. Cl. B41J 2/165; B41J 13/03

(52) U.S. Cl. CPC B41J 2/16505; B41J 2/16585; B41J 13/03; B41J 2002/16594; B41P 2235/27

(57) ABSTRACT

A maintenance apparatus includes: a cap contactable with a nozzle surface of a liquid discharge head; a suction unit coupled to the cap to suck a liquid in the cap; a valve coupled to the cap with a first path, the valve to cause the first path to be opened and closed to an atmosphere; a second path branched from the first path; and an opening port coupled to the second path and communicating with the atmosphere.

### CROSS-REFERENCE TO RELATED APPLICATIONS

This patent application is based on and claims priority pursuant to 35 U.S.C. § 119(a) to Japanese Patent Application No. 2023-022686, filed on Feb. 16, 2023, in the Japan Patent Office, and Japanese Patent Application No. 2023-089960, filed on May 31, 2023, in the Japan Patent Office, the entire disclosure of which are hereby incorporated by reference herein.

### BACKGROUND

### Technical Field

The present disclosure relates to a maintenance apparatus, a liquid discharge apparatus, and a maintenance method.

### Description of the Related Art

It is known that, in a liquid discharge apparatus using a liquid discharge head, a maintenance apparatus is used which performs maintenance on the liquid discharge head. The maintenance apparatus absorbs or sucks ink from, for example, the liquid discharge head to restore dischargeability.

For example, in order to perform maintenance, some maintenance apparatuses bring a suction cap into contact with a nozzle surface of a liquid discharge head and perform suction by means of a pump or the like to establish a negative pressure in the suction cap. Such a method is disadvantageous in that the nozzle surface is affected by a change in pressure in the suction cap when the suction cap is separated from the nozzle surface after suction is performed. For example, a change in pressure in the suction cap may damage a meniscus of a nozzle hole to cause a discharge failure. In order to eliminate such a failure, there has been proposed a technique of causing a path coupled to a suction cap to communicate with the atmosphere and then separating the suction cap from a nozzle surface.

### SUMMARY

According to an aspect of the present disclosure, a maintenance apparatus includes: a cap contactable with a nozzle surface of a liquid discharge head; a suction unit coupled to the cap to suck a liquid in the cap; a valve coupled to the cap with a first path, the valve to cause the first path to be opened and closed to an atmosphere; a second path branched from the first path; and an opening port coupled to the second path and communicating with the atmosphere.

According to another aspect of the present disclosure, a maintenance method includes causing a cap to contact with a nozzle surface of a liquid discharge head; closing a valve coupled to the cap with a first path; and sucking a liquid in the cap while air is supplied to the cap from an opening port coupled to a second path communicating with an atmosphere, the second path branched from the first path.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1A is a schematic diagram illustrating an example of a maintenance apparatus and a liquid discharge apparatus according to the present disclosure, and is a diagram illustrating an example of a state in which a cap is not in contact with a nozzle surface;

FIG. 1B is a schematic diagram illustrating an example of the maintenance apparatus and the liquid discharge apparatus according to the present disclosure, and is a diagram illustrating an example of a state in which the cap is performing suction while in contact with the nozzle surface;

FIG. 2 is a schematic cross-sectional view of an example of a micro-opening port;

FIG. 3 is a schematic diagram illustrating another example of the maintenance apparatus and the liquid discharge apparatus according to the present disclosure;

FIG. 4 is a schematic diagram illustrating another example of the maintenance apparatus and the liquid discharge apparatus according to the present disclosure;

FIG. 5 is a schematic diagram illustrating another example of the maintenance apparatus and the liquid discharge apparatus according to the present disclosure;

FIG. 6 is a schematic diagram illustrating another example of the maintenance apparatus and the liquid discharge apparatus according to the present disclosure;

FIG. 7 is a schematic diagram illustrating another example of the liquid discharge apparatus according to the present disclosure;

FIG. 8 is a diagram illustrating an example of a hardware configuration of a controller;

FIG. 9 is a schematic diagram illustrating a maintenance apparatus according to a comparative example not included in the present disclosure;

FIG. 10A is a diagram illustrating entry of ink into an atmosphere release path in the comparative example;

FIG. 10B is a diagram illustrating residual ink in the atmosphere release path;

FIG. 10C is a diagram illustrating entry of ink into an atmosphere release valve;

FIG. 11 is a diagram illustrating an example of aggregation of ink;

FIG. 12 is a graph illustrating an example of changes in pressure in suction caps in an example and the comparative example;

FIG. 13A is a diagram illustrating an example of a case where there are multiple liquid discharge heads and multiple suction caps, and is a diagram illustrating an example of a case where the suction caps are not in contact with the liquid discharge heads;

FIG. 13B is a diagram illustrating an example of a case where the suction caps are in contact with the liquid discharge heads in FIG. 13A;

FIG. 14A is a diagram illustrating another example in which there are multiple liquid discharge heads and multiple suction caps, and is a diagram illustrating an example of a case where the suction caps are not in contact with the liquid discharge heads;

FIG. 14B is a diagram illustrating an example of a case where the suction caps are in contact with the liquid discharge heads in FIG. 14A;

FIG. 15 is a schematic cross-sectional view of an example of the suction cap;

FIG. 16A is a diagram illustrating an example of a case where a cap sealing member is in contact with the suction caps and the opening and closing of an intermediate release valve is controlled in FIG. 14A;

FIG. 16B is a diagram illustrating an example of a case where an atmosphere release valve is opened in FIG. 16A;

FIGS. 17AA and 17AB are diagrams illustrating an example of a case where liquid inside a first path does not form a meniscus; and

FIGS. 17BA and 17BB are diagrams illustrating an example of a case where liquid inside the first path forms a meniscus.

The accompanying drawings are intended to depict embodiments of the present invention and should not be interpreted to limit the scope thereof. The accompanying drawings are not to be considered as drawn to scale unless explicitly noted.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Hereinafter, a maintenance apparatus, a liquid discharge apparatus, and a maintenance method according to the present disclosure will be described with reference to the drawings. Note that the following embodiments are not limiting the present disclosure and any deletion, addition, modification, change, etc. can be made within a scope in which person skilled in the art can conceive including other embodiments, and any of which is included within the scope of the present disclosure as long as the effect and feature of the present disclosure are demonstrated.

A maintenance apparatus according to the present disclosure includes: a cap that can be brought into contact with a nozzle surface of a liquid discharge head; a suction unit that is coupled to the cap and sucks air out of the cap; an opening and closing unit that is coupled to the cap by a first path and causes the first path to be opened and closed to an atmosphere; the first path coupling the cap and the opening and closing unit; and an opening port that causes the first path to communicate with the atmosphere.

A liquid discharge apparatus according to the present disclosure includes: a liquid discharge head; and the maintenance apparatus according to the present disclosure. The liquid discharge apparatus may be referred to as an image forming apparatus, a printer, a printing apparatus, or the like.

A maintenance method according to the present disclosure is a maintenance method to be performed by the maintenance apparatus according to the present disclosure, and includes a cleaning step of bringing the cap into contact with the nozzle surface of the liquid discharge head, closing the opening and closing unit, and causing the suction unit to operate.

### First Embodiment

An embodiment of the present disclosure will be described.

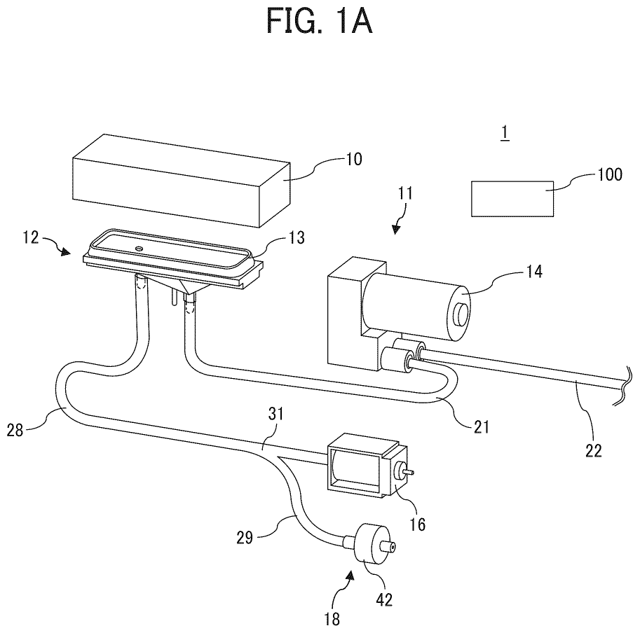

FIGS. 1A and 1B are schematic diagrams illustrating an example of a maintenance apparatus according to the present embodiment. A maintenance apparatus 11 of the present example includes a liquid discharge head 10, a suction cap 12, a suction pump 14, an atmosphere release valve 16, and a micro-opening port 18. A liquid discharge apparatus 1 of the present example includes the liquid discharge head 10 and the maintenance apparatus 11. FIG. 1A is a diagram illustrating an example of a state in which the suction cap 12 is not in contact with a nozzle surface of the liquid discharge head 10. FIG. 1B is a diagram illustrating an example of a state in which the suction cap 12 is performing suction while in contact with the nozzle surface of the liquid discharge head 10.

The suction cap 12 is an example of the above-described cap, and includes, for example, a cap member 13 and a base member that holds the cap member 13. The cap member 13 may be, for example, a member having elasticity. In a case where the cap member 13 is a member having elasticity, it is possible to ensure more adhesion when the suction cap 12 comes into contact with the liquid discharge head 10.

The suction cap 12 is coupled to the suction pump 14 by a first liquid path 21.

The suction pump 14 is an example of the above-described suction unit. Liquid on the nozzle surface of the liquid discharge head 10 is sucked by the suction pump 14, and flows in a direction of arrow A through the first liquid path 21. The suction pump 14 can perform suction to generate a negative pressure in the suction cap 12. Therefore, the suction pump 14 may be referred to as a negative pressure generation unit or the like.

The suction pump 14 is coupled to a second liquid path 22. The liquid sucked by the suction pump 14 flows in a direction of arrow B to a waste liquid tank through the second liquid path 22.

The suction unit is preferably, for example, a diaphragm pump. When a diaphragm pump is used as the suction unit, it is possible to cause pressure to rapidly increase. As a result, the influence of pressure loss at the micro-opening port can be reduced.

The suction cap 12 and the atmosphere release valve 16 are coupled by a first path 28.

The first path 28 may be referred to as an atmosphere release path or the like.

The atmosphere release valve 16 is an example of the above-described opening and closing unit. The atmosphere release valve 16 is coupled to the suction cap 12 by the first path 28, and causes the first path 28 to be opened and closed to the atmosphere.

The opening and closing unit is preferably, for example, an electromagnetic valve. In a case where an electromagnetic valve is used as the opening and closing unit, the opening and closing unit can independently function to make the first path 28 open to the atmosphere. Operation of the electromagnetic valve is not particularly limited, but for example, opening and closing are electrically controlled.

An example of operation of the suction cap 12, the suction pump 14, and the atmosphere release valve 16 will be described.

For example, when the suction pump 14 performs suction in a state where the atmosphere release valve 16 is closed and the suction cap 12 is in contact with the nozzle surface of the liquid discharge head 10, a negative pressure is established in a space between the suction cap 12 and the nozzle surface of the liquid discharge head 10. In this way, the suction cap 12 can perform suction.

Next, the atmosphere release valve 16 is opened while suction is being performed in a state where the suction cap 12 is in contact with the nozzle surface of the liquid discharge head 10. As a result, air flows in a direction of arrow C from the atmosphere release valve 16 through the first path 28 while pressure in the space between the suction cap 12 and the nozzle surface of the liquid discharge head 10 is kept at a level close to the atmospheric pressure. At this time, ink in the suction cap 12 can be discharged. However, as will be described in a section of a comparative example below, when the suction pump 14 is stopped, ink flows into the first path 28 in the conventional technique.

The maintenance apparatus of the present example includes the micro-opening port 18 that allows the first path 28 to communicate with the atmosphere. The micro-opening port 18 is an example of the above-described opening port.

Since the micro-opening port 18 is provided, the inside of the first path 28 constantly communicates with the atmosphere. As a result, even when the suction pump 14 stops, air flows in from the micro-opening port 18. Thus, air constantly flows in the direction of arrow C in FIG. 1B. That is, even when the suction pump 14 stops, air flows toward the suction cap 12 in the first path 28. Therefore, when the suction pump 14 is stopped, ink can be prevented from flowing into the first path 28 from the suction cap 12. The operational effects of the present embodiment will also be described below, and will also be described in the section of a comparative example below.

The opening port 18 can be appropriately selected. For example, the opening port 18 includes an open hole forming member 43 in which an open hole communicating with the atmosphere has been formed. The open hole forming member 43 is coupled to the first path 28 by a second path 29 that is a branch of the first path 28. That is, the second path 29 is branched from the first path 28.

As described above, it is possible to easily produce the opening port 18 by using the open hole forming member 43 in which the open hole has been formed. In addition, in the case of, for example, changing the size of the open hole, it is possible to cope with the change by changing the open hole forming member 43. Thus, it is easy to cope with a design change.

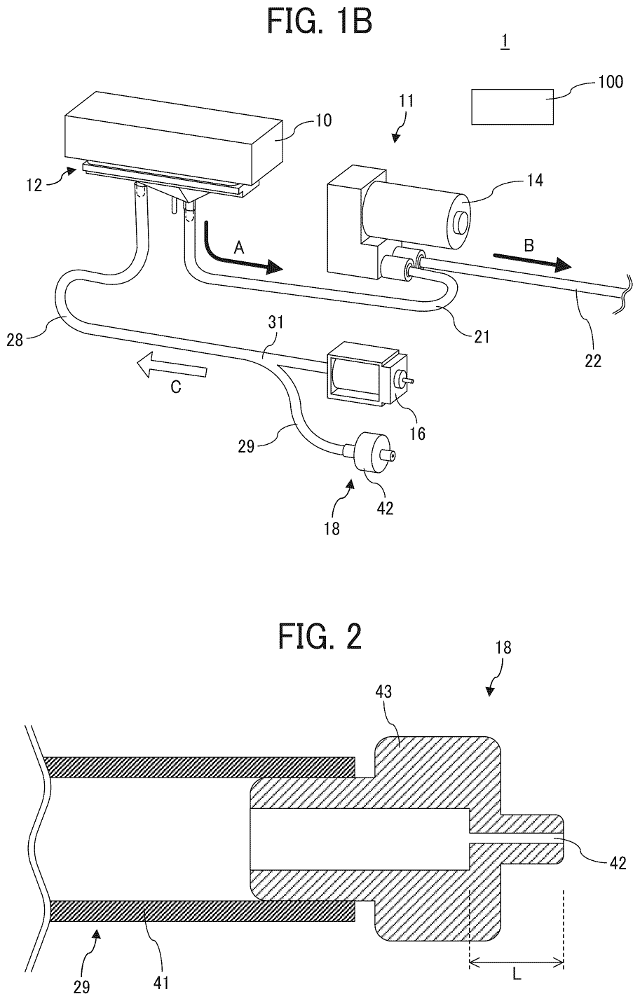

FIG. 2 is a schematic cross-sectional view of an example of the micro-opening port 18. The micro-opening port 18 of the present example includes the open hole forming member 43. An open hole 42 has been formed in the open hole forming member 43. The open hole forming member 43 is coupled to the second path 29. The second path 29 is formed of, for example, a tube 41. The open hole 42 may be referred to as a micro-open hole or the like.

The open hole forming member 43 can be appropriately selected, and is preferably an inelastic member, for example. When the open hole forming member 43 is an inelastic member, it is possible to prevent a change in the diameter of the open hole 42 due to a change in pressure. The open hole forming member 43 may be an elastic member. In this case, however, the diameter of the open hole 42 may change due to a change in pressure.

When the suction pump 14 stops while driven, air flows in through the open hole 42 while the suction cap 12 is under negative pressure. Therefore, since air constantly flows as indicated by arrow C in FIG. 1B, ink can be prevented from flowing into the first path 28 from the suction cap 12 during suction operation.

The diameter of the open hole 42 can be appropriately selected, and is preferably adjusted according to use conditions such as pumping power and working pressure. If the diameter of the micro-open hole is too large, pressure in the suction cap 12 may be less likely to be a desired pressure when the suction cap 12 performs suction while in contact with the nozzle surface. If the diameter of the open hole 42 is too small, ink may flow into the first path 28 when the suction pump 14 is stopped to make the first path 28 open to the atmosphere. Therefore, it is desirable to set the diameter of the open hole 42 to an appropriate and extremely small value. In this case, it is possible to minimize pressure leakage that occurs when the suction pump 14 is driven. As a result, influence on the suction state of the suction cap 12 can be reduced.

A description will be given of an application example of pumping power and the micro-opening port. However, the present disclosure is not limited thereto. When numerical conditions as set forth below are satisfied, the above effect is easily obtained. Thus, it is desirable that such numerical conditions be satisfied. This is because, for example, pressure in the suction cap 12 is easily set to a desired pressure and thus, inflow of ink is easily prevented. The length of the open hole 42 is denoted by L in FIG. 2.

### Example of Relationship Between Pumping Power and Diameter of Open Hole

Maximum ultimate suction negative pressure in the suction cap 12: −50 to −70 kPa

Diameter of open hole: 0.05 to 0.2 mm

Length of open hole: 2 to 4 mm

A position where the micro-opening port 18 is provided can be appropriately selected. For example, the micro-opening port 18 is preferably provided at a position immediately before the opening and closing unit (atmosphere release valve 16). In this case, ink can be further prevented from flowing into the atmosphere release valve 16.

Here, the atmosphere release valve 16 has a path communicating with an atmosphere, and a diameter of the open hole 42 is made smaller than a diameter of the path of the atmosphere release valve 16.

The term “position immediately before” refers to a position defined as follows, for example. The first path 28 is coupled to the second path 29 at a coupling point 31. The coupling point 31 is served also as a “branching point” at which the second path 29 is branched from the first path 28.

On the first path 28, the coupling point 31 is located closer to the atmosphere release valve 16 than to the suction cap 12. Assuming that a distance along the first path 28 from the suction cap 12 to the atmosphere release valve 16 is 1, a distance from the coupling point 31 to the atmosphere release valve 16 is preferably equal to or less than ½, and is more preferably equal to or less than ⅓. In the examples illustrated in FIGS. 1A and 1B, the distance from the coupling point 31 to the atmosphere release valve 16 is equal to or less than ⅓.

Thus, a length of the first path 28 from the coupling point 31 (branching point) to the valve (atmosphere release valve 16) is less than a half of a length of the first path 28 from the suction cap 12 to the valve (atmosphere release valve 16).

FIG. 3 is a diagram for describing an example of a maintenance method of the present embodiment.

A maintenance method according to the present disclosure is a maintenance method to be performed by the maintenance apparatus according to the present disclosure, and includes a cleaning step of bringing the cap into contact with the nozzle surface of the liquid discharge head, closing the opening and closing unit, and causing the suction unit to operate.

An example of maintenance will be described.

The suction cap 12 is brought into contact with the nozzle surface of the liquid discharge head 10 and then, the suction pump 14 is driven. As a result, a negative pressure is established in the suction cap 12, and ink is sucked and discharged from the liquid discharge head 10. The liquid (for example, ink) sucked by the suction cap 12 flows through the first liquid path 21 in a direction of arrow A in the drawing. Then, the sucked liquid flows through the second liquid path 22 to the waste liquid tank. While suction is performed in this way, air flows through the first path 28 in a direction of arrow C.

Next, the suction pump 14 is stopped. After the suction pump 14 is stopped, pressure in the suction cap 12 is relieved as ink is discharged from the liquid discharge head 10. Next, the atmosphere release valve 16 is opened immediately before the suction cap 12 is separated from the liquid discharge head 10. This increases the amount of air flowing into the suction cap 12. As a result, it is possible to prevent a change in pressure to be caused when the suction cap 12 is separated from the liquid discharge head 10.

Note that this change in pressure affects the nozzle surface, and damages a meniscus, for example. Therefore, the atmosphere release valve 16 is opened before the suction cap 12 is separated from the liquid discharge head 10. As a result, it is possible to prevent a change in pressure in the suction cap.

After the atmosphere release valve 16 is opened, the suction cap 12 is separated from the liquid discharge head 10. In this way, a single unit of cleaning operation is completed. Although not particularly limited, a series of actions of, for example, coming into contact with the nozzle surface, performing suction, and then moving away from the nozzle surface is defined as a single unit of cleaning operation, the series of actions being performed by the suction cap 12.

In the present embodiment, the micro-opening port 18 is provided. A description will be given of an example of how the micro-opening port 18 functions in the above cleaning operation.

When suction is performed by the suction pump 14 in a state where the suction cap 12 is in contact with the nozzle surface, the atmosphere release valve 16 is closed. However, since atmosphere release suction to be described below may also be performed, the atmosphere release valve 16 is not necessarily closed when the suction pump 14 operates.

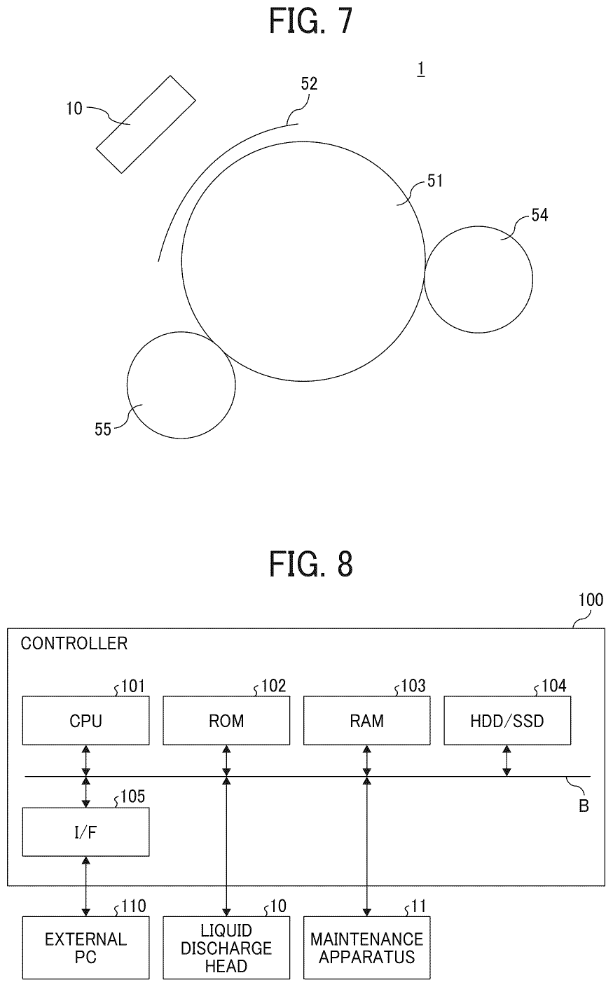

When suction is performed by the suction pump 14 in a state where the suction cap 12 is in contact with the nozzle surface, air flows in the first path 28 (atmosphere release path) as indicated by arrow C. Even when the micro-opening port 18 is not provided, such an air flow is generated (also illustrated in FIG. 7 to be described below). This is because air needs to flow into the suction cap 12 when the suction pump 14 sucks air out of the suction cap 12.

When suction is performed by the suction pump 14 in a state where the suction cap 12 is in contact with the nozzle surface, air flows in the first path 28 but the first path 28 is under negative pressure. In the present embodiment, the first path 28 communicates with the atmosphere by means of the micro-opening port 18, but a negative pressure is established in the first path 28 when suction is performed by the suction pump 14. Although the magnitude of the negative pressure varies depending on the configuration of the micro-opening port 18 (for example, the size of the open hole), the pumping power of the suction pump 14, and the like, the first path 28 is under negative pressure during suction also in the present embodiment.

At this time, when the suction pump 14 is stopped, pressure in the first path 28 easily returns from negative pressure to the atmospheric pressure due to the effect of the micro-opening port 18. Therefore, since the micro-opening port 18 is provided, pressure in the first path 28 quickly returns to the atmospheric pressure when the suction pump 14 is stopped and the atmosphere release valve 16 is opened. As a result, when the suction cap 12 is separated after the suction pump 14 is stopped and the atmosphere release valve 16 is opened, pressure in the first path 28 is equal to the atmospheric pressure. Thus, ink can be prevented from flowing into the first path 28.

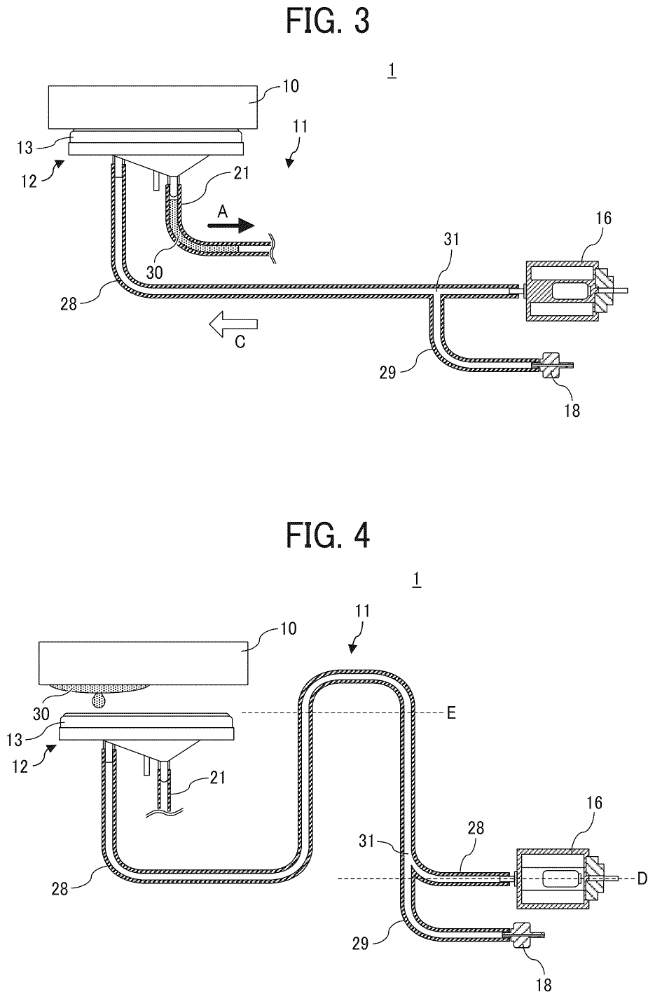

FIG. 4 is a diagram illustrating another example of the maintenance apparatus according to the present embodiment.

As in the present example, a part of the first path 28 is preferably located above a point where the first path 28 is coupled to the atmosphere release valve 16, in a vertical direction. In the drawing, the height of the point where the first path 28 is coupled to the atmosphere release valve 16 is indicated by broken line D.

In this way, even if ink drips from the liquid discharge head 10 and enters the first path 28 due to an anomalous action or the like, the ink can be prevented from flowing toward the atmosphere release valve 16. When ink enters the first path 28 due to an anomalous action or the like, the ink having entered the first path 28 needs to climb over a portion of the first path 28 higher than the height of an insertion port of the atmosphere release valve 16. Therefore, even if ink enters the first path 28, the ink can be further prevented from flowing toward the atmosphere release valve 16.

In the case of the present example, even if ink enters the first path 28 from the liquid discharge head 10, the ink can be further prevented from flowing toward the atmosphere release valve 16. It is thus possible to prevent the ink from clogging the atmosphere release valve 16 and the micro-opening port 18.

In addition, as in the present example, a part of the first path 28 is preferably located above a level on which the suction cap 12 comes into contact with the nozzle surface of the liquid discharge head 10, in the vertical direction. In the drawing, the level on which the suction cap 12 comes into contact with the nozzle surface of the liquid discharge head 10 is indicated by broken line E.

Thus, the cap 12 contacts the nozzle surface of a liquid discharge head 10 at a contact position in the vertical direction, and the part of the first path 28 is above the contact position in the vertical direction.

In this manner, the above effect can be further enhanced. Even if ink enters the first path 28 due to an anomalous action or the like, it is possible to further prevent ink from clogging the atmosphere release valve 16 and the micro-opening port 18.

When the nozzle surface of the liquid discharge head 10 is inclined with respect to a horizontal direction, the suction cap 12 comes into contact with a highest point of the nozzle surface of the liquid discharge head 10.

Although not particularly limited, the above configuration can be easily achieved when the first path 28 is formed with a tube. For example, a flexible material can be used as the tube.

Next, another example of the present embodiment will be described.

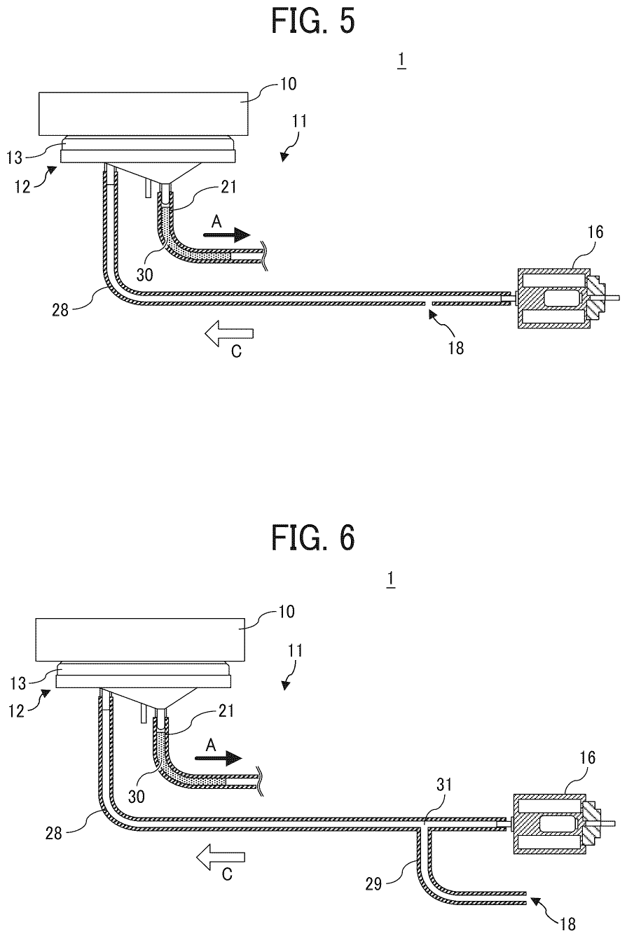

FIG. 5 is a diagram for describing a maintenance apparatus of the present example. The opening port 18 in present example is a hole formed in the first path 28. The hole communicating with the atmosphere is formed in the first path 28 in this manner. As a result, it is possible to downsize the apparatus. Also in the present example, the opening port 18 allows the first path 28 to communicate with the atmosphere. Therefore, ink can be prevented from flowing into the first path 28.

Also in the present example, the size of the hole is preferably set in consideration of, for example, a relationship with pumping power. For example, it is preferable to consider the section “Example of Relationship between Pumping Power and Diameter of Open Hole” described above.

The position of the hole (opening port 18) formed in the first path 28 can be appropriately selected. For example, the hole is preferably provided at a position immediately before the opening and closing unit (atmosphere release valve 16). In this case, ink can be further prevented from flowing into the atmosphere release valve 16.

The term “position immediately before” refers to a position defined as follows, for example. On the first path 28, the opening port 18 is preferably provided closer to the atmosphere release valve 16 than to the suction cap 12. Assuming that the distance along the first path 28 from the suction cap 12 to the atmosphere release valve 16 is 1, a distance from the opening port 18 to the atmosphere release valve 16 is preferably equal to or less than ½, and is more preferably equal to or less than ⅓.

Next, another example of the present embodiment will be described.

FIG. 6 is a diagram for describing a maintenance apparatus of the present example. In the present example, the first path 28 has the second path 29 that is a branch of the first path 28. The second path 29 has a hole at an end opposite to the first path 28. The hole serves as the opening port 18. With such a configuration, the apparatus can be downsized. Also in the present example, the opening port 18 allows the first path 28 to communicate with the atmosphere. Therefore, ink can be prevented from flowing into the first path 28.

In the present example, the second path 29 is formed with, for example, a tube. Therefore, it can be said that the opening port 18 in the present example is formed by use of a tube. A hole at an end of the tube is used as the opening port 18. As a result, the apparatus can be downsized and easily produced.

The liquid discharge apparatus according to the present disclosure includes a liquid discharge head, and the maintenance apparatus according to the present disclosure. It can also be said that the liquid discharge apparatus according to the present disclosure is illustrated in, for example, FIGS. 1A and 1B described above. The maintenance apparatus according to the present disclosure can prevent ink from flowing into the atmosphere release path. Therefore, maintenance can be favorably performed for the liquid discharge apparatus according to the present disclosure for a long period of time. Thus, the liquid discharge apparatus according to the present disclosure can form a favorable image for a long period of time.

The liquid discharge head can be appropriately selected. For example, it is possible to use, as the liquid discharge head, a serial head-type liquid discharge head. Alternatively, a line head-type liquid discharge head may be used. The liquid discharge head is preferably a line head-type liquid discharge head. In the case of a line head-type liquid discharge head, it is possible to perform cleaning without fail even in a case where the number of times cleaning is performed increases, such as a case where air is sucked out of the suction cap 12 multiple times.

When the liquid discharge head is a line head-type liquid discharge head, the configuration thereof can be appropriately selected. For example, multiple nozzle rows may be provided on the nozzle surface of the liquid discharge head, and the nozzle rows may be shifted and arranged in a staggered manner. In addition, the liquid discharge head may be configured as a full line head.

The liquid discharge apparatus according to the present disclosure may include a head unit. In the head unit, a full-line type head array for four colors can be arranged from, for example, an upstream side in a conveyance direction. For example, black, cyan, magenta, and yellow liquids are discharged from this head array. Note that the number and types of color are not limited to the above-described four colors of black, cyan, magenta, and yellow, and may be any other suitable number and types. The configuration of the head array is not limited thereto. For example, the liquid discharge heads 10 may be arranged in a staggered manner on the base member in the head array.

The configuration of the liquid discharge head 10 is not limited, and a liquid discharge head with any configuration can be adopted as long as the liquid discharge head discharges liquid. If necessary, it is possible to provide a liquid discharge head that discharges special ink such as white, gold, or silver, or a liquid discharge head that discharges liquid that does not form an image, such as surface coating liquid.

A recording medium onto which liquid is discharged from the liquid discharge head 10 is not particularly limited, and can be appropriately selected. A means for conveying the recording medium is not particularly limited, and can be appropriately selected. The recording medium may be conveyed by, for example, a drum-shaped conveyor (drum conveyor).

An example of the liquid discharge apparatus includes a drum-shaped conveyor facing a liquid discharge head. The liquid discharge head discharges liquid onto a recording medium being conveyed by the conveyor. When the drum-shaped conveyor is used in this manner, the nozzle surface of the liquid discharge head is inclined with respect to a horizontal plane. However, the maintenance apparatus according to the present disclosure can perform cleaning even if the nozzle surface of the liquid discharge head is inclined with respect to the horizontal plane.

FIG. 7 is a schematic diagram illustrating another example of the liquid discharge apparatus according to the present disclosure. Here, illustration of the maintenance apparatus is omitted.

As illustrated in the drawing, the liquid discharge apparatus 1 of the present example includes a drum-shaped conveyor 51 facing the liquid discharge head 10. The liquid discharge head 10 discharges liquid onto a recording medium 52 being conveyed by the drum-shaped conveyor 51. As in the present example, even if the nozzle surface of the liquid discharge head 10 is inclined with respect to the horizontal plane, the suction cap 12 can perform cleaning while in contact with the nozzle surface.

In the present embodiment, when suction is performed for the liquid discharge head 10 that is inclined, ink in the suction cap 12 is discharged and then, the suction cap 12 is separated from the liquid discharge head 10. As a result, it is possible to prevent a phenomenon in which ink spills out of the suction cap 12.

Also in the example illustrated in the drawing, the liquid discharge head 10 can be appropriately selected. For example, multiple liquid discharge heads 10 may be provided. Alternatively, the liquid discharge apparatus may include a head unit.

For example, it is possible to use a sheet carrying drum as the drum-shaped conveyor 51. In addition, the liquid discharge apparatus 1 of the present example may include a receiving copper 54 and a delivery copper 55. The receiving copper 54 conveys a recording medium conveyed from a sheet feeding unit to the sheet carrying drum.

The delivery copper 55 conveys the recording medium conveyed from the sheet carrying drum. Heating, drying, and the like may be performed as necessary.

Maintenance operation to be performed by the maintenance apparatus according to the present embodiment can be appropriately changed. The maintenance apparatus is controlled by, for example, a controller included in the liquid discharge apparatus.

A controller 100 controls operation of the entire liquid discharge apparatus 1, for example. Although FIGS. 1A and 1B illustrate the controller 100 in the liquid discharge apparatus 1, the controller 100 may be installed at any position inside or outside the apparatus. In the drawings other than FIGS. 1A and 1B, illustration of the controller 100 is omitted.

FIG. 8 is a block diagram illustrating an example of a hardware configuration of the controller 100. The controller 100 includes a central processing unit (CPU) 101, a read only memory (ROM) 102, a random access memory (RAM) 103, a hard disk drive (HDD)/solid state drive (SSD) 104, and an interface (I/F) 105. These components are electrically connected to each other via a system bus B, and are connected to the liquid discharge head 10, the maintenance apparatus 11, and the like such that data and signals can be transmitted and received via the system bus B.

Note that a functional unit illustrated as the liquid discharge head 10 in the drawing may be defined as a liquid discharger including the liquid discharge head 10.

The CPU 101 uses the RAM 103 as a work area, and executes a program stored in the ROM 102. The HDD/SSD 104 is used as a storage unit, and stores a preset setting value. The CPU 101 may read information stored in the HDD/SSD 104 and use the information to execute the program. The I/F 105 is, for example, an interface that enables communication between the liquid discharge apparatus 1 and an external personal computer (PC) 110.

The controller 100 controls the maintenance apparatus 11. In controlling the maintenance apparatus 11, the controller 100 controls, for example, the suction cap 12, the suction pump 14, and the atmosphere release valve 16. Although not particularly limited, the controller 100 controls, for example, contact and separation between the suction cap 12 and the liquid discharge head 10, the driving and stopping of the suction pump 14, and the opening and closing of the atmosphere release valve 16.

Maintenance operation to be performed under the control of the controller 100 can be appropriately selected. For example, assuming that a series of actions of coming into contact with the nozzle surface, performing suction, and then moving away from the nozzle surface is defined as a single unit of cleaning operation, the series of actions being performed by the suction cap 12, the controller 100 preferably performs control in such a way as to cause the suction pump 14 to repeat operation and non-operation for multiple times in the single unit of cleaning operation. As a result of causing the suction pump 14 to repeat operation and non-operation multiple times in this manner, even in a case where the micro-opening port 18 is provided, it is possible to perform the same amount of suction as in a case where the micro-opening port 18 is not provided.

When performing the above control, the controller 100 preferably performs control in such a way as to cause the suction pump 14 to repeat operation and non-operation multiple times in a state where the atmosphere release valve 16 is closed in the single unit of cleaning operation, and then to open the atmosphere release valve 16. This makes it easier to prevent ink from flowing into the first path 28 when the atmosphere release valve 16 is opened.

Thus, wherein the circuitry (controller 100) is further configured to: bring the cap (12) into contact with the nozzle surface of the liquid discharge head (10, 10a, 10b); close the valve (16); cause the suction unit (14) to repeatedly perform: sucking the liquid from the cap (12); and temporarily stop sucking the liquid from the cap (12), for multiple times while the cap (12) contacts the nozzle surface and the valve (16) is closed as a sucking operation; and open the valve (16) after the sucking operation of the suction unit (14).

Next, the present embodiment will be further described by use of a comparative example not included in the present disclosure.

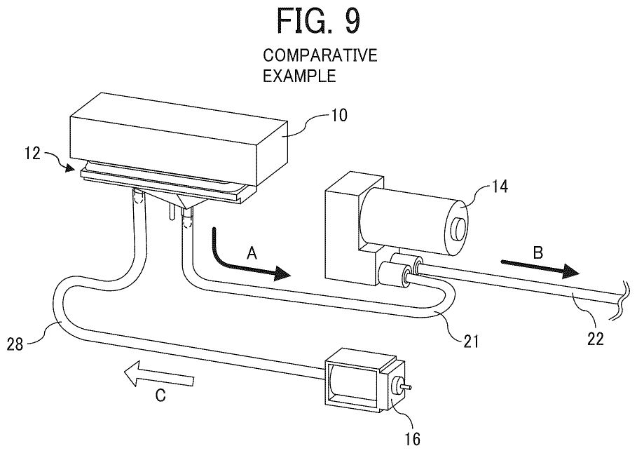

FIG. 9 is a schematic view of a maintenance apparatus of the present comparative example. The maintenance apparatus of the present comparative example includes a suction cap 12, a suction pump 14, and an atmosphere release valve 16, but includes no micro-opening port 18.

Also in the present comparative example, the suction cap 12 is brought into contact with a nozzle surface of a liquid discharge head 10 and then, the suction pump 14 is driven in a state where the atmosphere release valve 16 is closed, to cause the suction cap 12 to perform suction. The atmosphere release valve 16 is opened while suction is being performed in a state where the suction cap 12 is in contact with the nozzle surface of the liquid discharge head 10. As a result, air flows in a direction of arrow C from the atmosphere release valve 16 through a first path 28 while pressure in a space between the suction cap 12 and the nozzle surface of the liquid discharge head 10 is kept at a level close to the atmospheric pressure. As a result, sucked ink flows along arrows A and B, and is sent to a waste liquid tank.

In the present comparative example, ink does not enter the first path 28 during suction while the suction pump 14 is driven to keep the suction cap 12 and the first path 28 under negative pressure. However, when the suction pump 14 stops in the case of the present comparative example, ink enters the first path 28 to cause a failure.

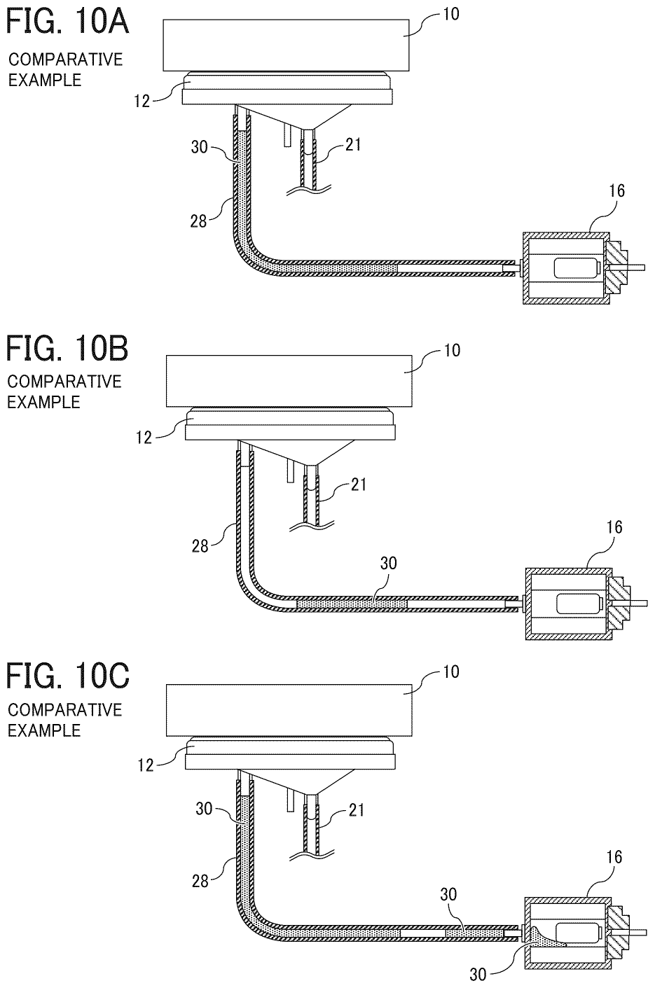

FIGS. 10A, 10B, and 10C are diagrams for describing a disadvantage of the present comparative example. FIGS. 10A, 10B, and 10C are arranged on a time-series basis.

FIG. 10A is a diagram schematically illustrating a case where the suction pump 14 is stopped after the suction pump 14 is operated in a state where the suction cap 12 is in contact with the nozzle surface of the liquid discharge head 10. As illustrated in the drawing, when the suction pump 14 stops and pressure in a space in the first path 28 returns from negative pressure to the atmospheric pressure, the flow of ink 30 from the suction cap 12 is generated in the first path 28.

When suction is stopped, the volume of air expanded by negative pressure in the path returns to an original volume. At this time, it is necessary to compensate for a difference from the original volume. Since the amount of air in the closed path does not change, the volume of space in the path is compensated by ink discharged from the liquid discharge head 10. Therefore, when suction is stopped, ink flows into the first path 28. Therefore, when suction is stopped, air does not flow from the suction pump 14, but ink discharged from the liquid discharge head 10 flows into the first path 28 due to the action of ink in the path (for example, in the suction cap 12) and the negative pressure in the first path 28.

The ink 30 that has thus flowed in may remain in the first path 28 depending on the amount of ink that has flowed in. FIG. 10B is a diagram schematically illustrating this state.

The ink 30 in the first path 28 may be discharged when the suction pump 14 is driven in a state where the atmosphere release valve 16 is open. However, depending on the amount of ink that has flowed in, the ink cannot be completely discharged and remains in the first path 28. Driving the suction pump 14 in a state where the atmosphere release valve 16 is open may also be referred to as atmosphere release suction.

The ink 30 remaining in the first path 28 may aggregate over time.

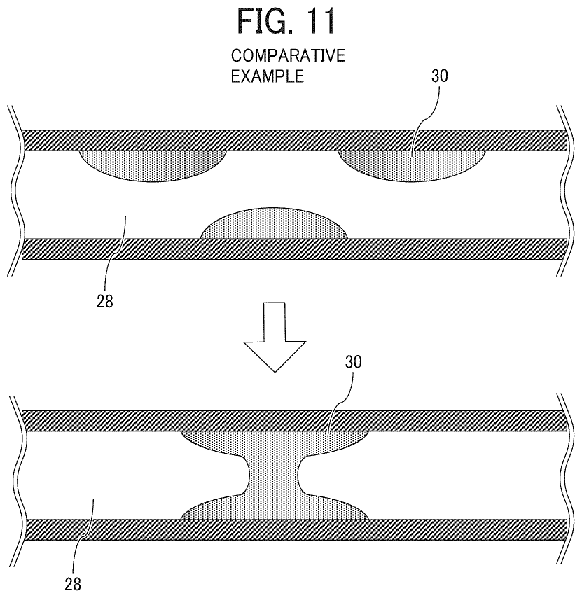

FIG. 11 is a diagram schematically illustrating an example of how the ink 30 remaining in the first path 28 changes with the passage of time. In the present comparative example, the ink 30 may remain in the first path 28 after atmosphere release suction is performed, as illustrated in an upper part of the drawing. When time elapses in this state, the ink may stick together and aggregate as illustrated in a lower part of the drawing.

The ink having aggregated in the first path 28 is less likely to be discharged even when atmosphere release suction is performed. Therefore, when maintenance operation is repeated, ink finally reaches the atmosphere release valve 16. When the ink reaches the atmosphere release valve 16, valve operation is inhibited.

FIG. 10C is a diagram for describing an example of a case where ink reaches the atmosphere release valve 16 in the present comparative example. A case where ink reaches the atmosphere release valve 16 and inhibits valve operation includes a case where ink reaches the atmosphere release valve 16 in a liquid state, in addition to a case where ink aggregates and reaches the atmosphere release valve 16 in a solid state.

Ink remaining in the first path 28 is pushed back to the atmosphere release valve 16 after next suction, and liquid ink may enter the atmosphere release valve 16. This state is also illustrated in FIG. 10C. When liquid ink is thickened in a state where the liquid ink is staying in the atmosphere release valve 16, a plunger does not slide, and the valve does not function, for example. For example, the disadvantage described above tends to be remarkable in a case where suction time is extended and a case where the viscosity of ink is high, in addition to a case where pressure is increased so as to increase recoverability.

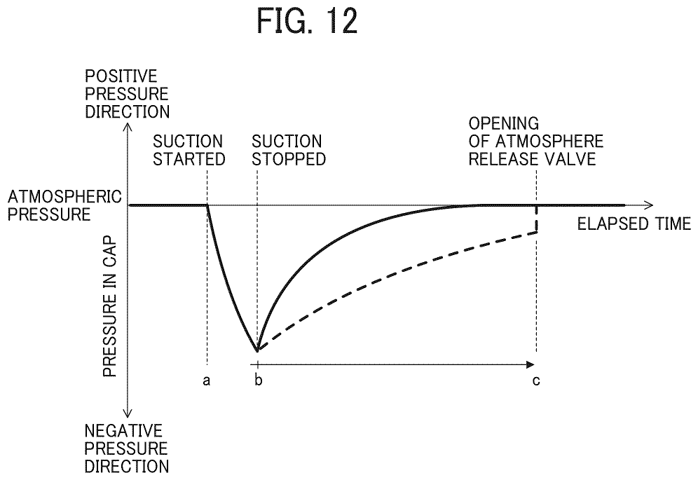

FIG. 12 is a graph for schematically describing an example and the comparative example with respect to temporal change of pressure in the suction cap 12. A solid line indicates an example (for example, FIG. 1A), and a broken line indicates the comparative example (for example, FIG. 9).

When suction is started, liquid on the nozzle surface of the liquid discharge head 10 is sucked and discharged (arrow A in FIG. 1B). As illustrated in FIG. 12, in a case where suction is started at a point “a”, pressure in the suction cap 12 decreases, and a negative pressure is established in the suction cap 12. The density of air in the first path 28 decreases due to suction, and air in the first path 28 swells.

When suction is stopped, the volume of the expanded air in the first path 28 returns to an original volume in a process in which pressure in the suction cap 12 returns to the atmospheric pressure after suction is stopped. At this time, since air flows from the micro-opening port 18 in the example, air does not flow from the suction cap 12 toward the first path 28. Therefore, ink can be prevented from flowing into the first path 28. Meanwhile, in the comparative example, when the volume of the expanded air in the first path 28 returns to an original volume, the volume is compensated by ink discharged from the liquid discharge head 10, and thus the ink flows into the first path 28.

FIG. 12 illustrates how change of pressure in the suction cap 12 differs depending on whether the micro-opening port 18 is provided. When suction is stopped at a point “b”, pressure in the suction cap 12 easily returns to the atmospheric pressure since the micro-opening port 18 is provided in the example. Meanwhile, since the micro-opening port 18 is not provided in the comparative example, pressure in the suction cap 12 returns to the atmospheric pressure at a lower speed than in the example. In the comparative example, ink starts to flow into the first path 28 at the point “b”, and ink continues to flow in until the atmosphere release valve 16 is opened, that is, until a point “c”.

The micro-opening port 18 used in the example is a hole small in diameter, and has high channel resistance.

Therefore, pressure changes in the example such that after suction is stopped, pressure returns to the atmospheric pressure at a higher speed than in the comparative example, but the pressure gradually decreases to the atmospheric pressure, as illustrated in FIG. 12.

In the example illustrated in FIG. 12, there is an interval between the stop of suction and the opening of the atmosphere release valve 16. That is, a time interval is provided between the point “b” and the point “c”. The time interval is thus provided for the following reasons. Since a negative pressure is also generated inside the liquid discharge head 10 during suction, ink may move back toward the liquid discharge head 10 if the path is opened to the atmosphere before pressure in the suction cap 12 is relieved. In this case, bubbles may be entrained as well as ink to cause a discharge failure. Thus, this is prevented.

Furthermore, in the comparative example, it is considered that even if control is performed in such a way as to open the atmosphere release valve 16 before stopping suction, ink cannot be prevented from flowing into the first path 28. The path resistance of the atmosphere release valve 16 is different from the path resistance of the micro-opening port 18 so as to perform atmosphere release suction. Therefore, even if the atmosphere release valve 16 is opened before suction is stopped, it is not possible to obtain the effect as in the example in which the micro-opening port 18 is provided.

### Second Embodiment

Next, another embodiment according to the present disclosure will be described below.

In the above embodiment, the present disclosure has been described by use of an example in which the single suction cap 12 is provided. However, the present disclosure is not limited thereto, and multiple suction caps 12 may be provided. In the present embodiment, a description will be given of a case where multiple liquid discharge heads and multiple suction caps (the above-described caps) are provided.

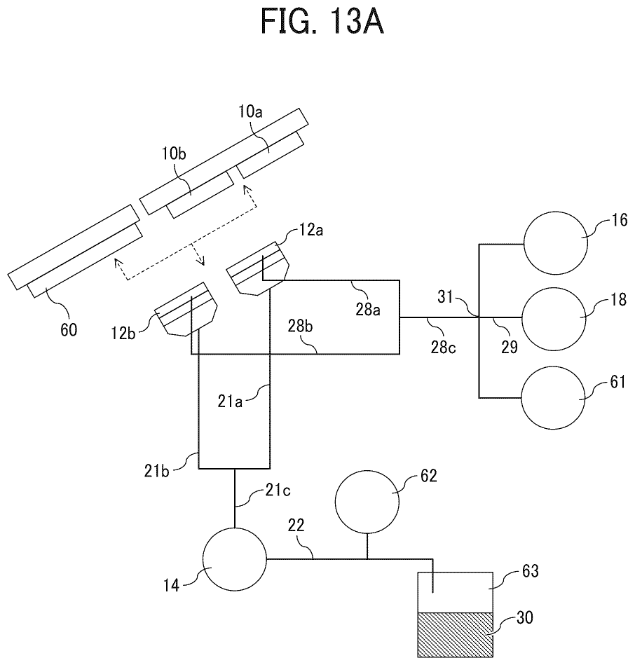

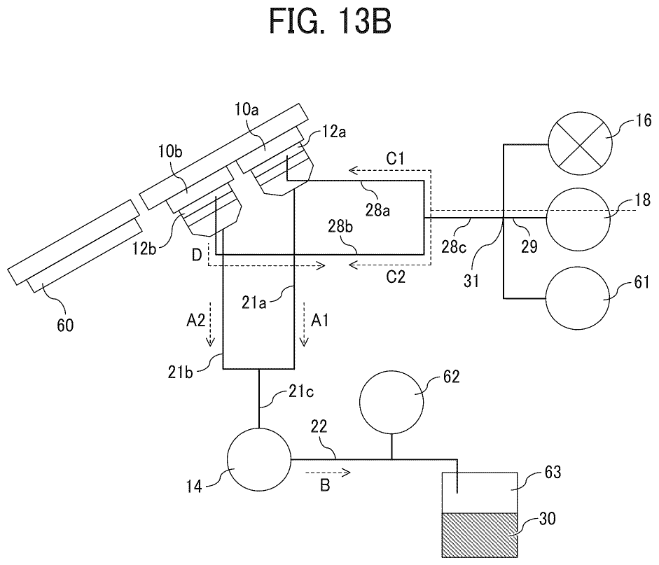

FIGS. 13A and 13B are diagrams for describing an example of a maintenance apparatus according to the present embodiment. FIG. 13A is a diagram illustrating an example of a case where caps are not in contact with liquid discharge heads. FIG. 13B is a diagram illustrating an example of a case where the caps are in contact with the liquid discharge heads.

Liquid discharge heads 10a and 10b are illustrated in the drawings. The maintenance apparatus of the present example includes suction caps 12a and 12b that can be brought into contact with the liquid discharge heads 10a and 10b, respectively.

Each of the suction caps is provided for corresponding one of the liquid discharge heads. As a result, when there is multiple liquid discharge heads, it is not necessary to use the same suction cap for different liquid discharge heads. It is thus possible to prevent liquid from adhering to another liquid discharge head.

The liquid discharge heads 10a and 10b will be referred to as liquid discharge heads 10 and the like when described without distinction. The suction caps 12a and 12b will be referred to as suction caps 12 and the like when described without distinction. The number of the liquid discharge heads 10 may be greater than two.

In the example illustrated in the present embodiment, an atmosphere release valve 16 and a suction pump 14 are common to the suction cap 12a and the suction cap 12b. When suction is performed by the suction pump 14 in a state where the suction caps 12a and 12b are respectively in contact with the liquid discharge heads 10a and 10b as illustrated in FIG. 13B, both the suction caps 12a and 12b can perform suction. Accordingly, when the suction pump 14 is caused to operate, it is possible to perform maintenance such as cleaning of nozzle surfaces of the liquid discharge heads 10a and 10b.

In addition, since the suction pump 14 is common to the suction cap 12a and the suction cap 12b, there is no need to increase the number of suction pumps 14. Thus, an increase in cost can be prevented.

As illustrated in FIG. 13B, when the atmosphere release valve 16 is closed and suction is performed by the suction pump 14, liquid from the liquid discharge head 10a passes through a first liquid path 21a on the suction cap 12a side, and liquid from the liquid discharge head 10b passes through a first liquid path 21b on the suction cap 12b side.

The liquid having passed through the first liquid path 21a and the first liquid path 21b passes through a first liquid path 21c provided in common, and flows to a waste liquid tank 63. Arrows A1 and A2 correspond to arrow A in the above embodiment. Arrow A1 indicates a flow on the suction cap 12a side. Arrow A2 indicates a flow on the suction cap 12b side.

As illustrated in FIG. 13B, when the atmosphere release valve 16 is closed and suction is performed by the suction pump 14, air flows through a first path 28 in a direction of arrow C as in the above embodiment. Arrows C1 and C2 correspond to arrow C in the above embodiment. Arrow C1 indicates a flow on the suction cap 12a side. Arrow C2 indicates a flow on the suction cap 12b side.

A micro-opening port 18 is provided also in the present embodiment. Therefore, ink can be prevented from flowing into first paths 28a and 28b from the suction caps 12a and 12b, respectively. The first path 28a is the first path 28 on the suction cap 12a side, and the first path 28b is the first path 28 on the suction cap 12b side. In present example, the first path 28a and the first path 28b join together to form a single first path 28 which is referred to as a first path 28c. In addition, a coupling point 31 at which the first path 28c is coupled to the second path 29 is illustrated.

In the example illustrated in the present embodiment, the micro-opening port 18 is common to the suction cap 12a and the suction cap 12b. The present example is advantageous in that since the micro-opening port 18 is common to multiple the suction caps 12, a device configuration is simplified. Meanwhile, when the first path 28a and the first path 28b differ in length and thus, there is a difference in resistance between the first path 28a and the first path 28b, suction force may vary between the multiple suction caps 12 to cause ink to flow into the first paths 28 from the suction caps 12. For example, in the drawing, arrow D schematically indicates that ink flows into the first path 28b from the suction cap 12b.

Meanwhile, as in a third embodiment below, ink can be more easily prevented from flowing into the first path 28 even when there is multiple suction caps 12.

### Third Embodiment

Next, another embodiment according to the present disclosure will be described below.

In the second embodiment above, the micro-opening port 18 is common to the multiple suction caps 12. Meanwhile, in the present embodiment, a micro-opening port 18 is provided for each of multiple suction caps 12. Accordingly, even when there are multiple suction caps 12, ink can be further prevented from flowing into a first path 28.

In the present embodiment, the liquid discharge head includes multiple liquid discharge heads, the cap and the opening port include multiple caps and multiple opening ports, respectively, each of the opening ports is provided for corresponding one of the multiple caps, and the suction unit and the opening and closing unit are common to the multiple caps, so that the suction unit is coupled to the multiple caps, and sucks air out of the multiple caps.

In the present embodiment, the micro-opening port 18 is provided for each of the multiple suction caps 12. It is thus possible to further prevent ink from flowing into the first path 28 even when there is multiple suction caps 12. For example, even when there may be a difference in resistance between the multiple suction caps 12 due to a difference in length of the first paths 28, ink can be prevented from flowing into the first paths 28.

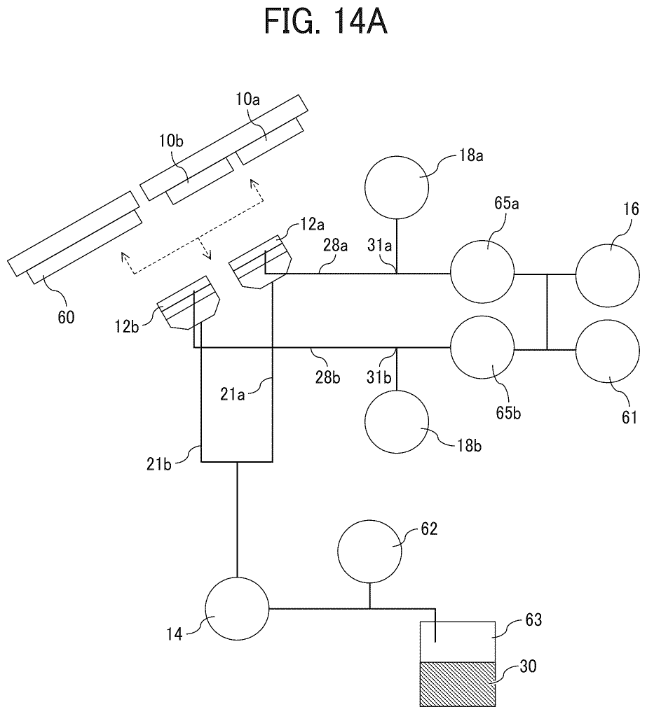

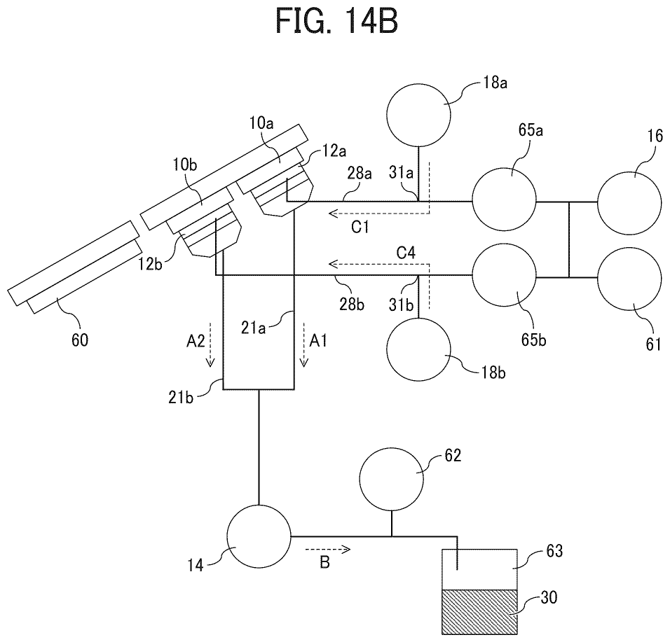

FIGS. 14A and 14B are diagrams for describing an example of a maintenance apparatus according to the present embodiment. FIG. 14A is a diagram illustrating an example of a case where the caps are not in contact with the liquid discharge heads. FIG. 14B is a diagram illustrating an example of a case where the caps are in contact with the liquid discharge heads.

As illustrated, each of the micro-opening ports 18 in the present embodiment is provided for corresponding one of multiple caps (suction caps 12). For example, a micro-opening port 18a is provided for the suction cap 12a, and a micro-opening port 18b is provided for the suction cap 12b. A suction pump 14 and an atmosphere release valve 16 are common to the multiple suction caps 12. The suction pump 14 is coupled to the multiple suction caps 12, and sucks air out of the multiple suction caps 12.

As illustrated in FIG. 14B, when suction is performed by the suction pump 14, an air flow indicated by arrow C3 is generated on the suction cap 12a side, and an air flow indicated by arrow C4 is generated on the suction cap 12b side. Arrows C3 and C4 correspond to arrow C in the first embodiment. As a result of providing the micro-opening ports 18a and 18b for the suction caps 12a and 12b, respectively, it is possible to prevent resistance from differing between paths for the suction caps 12a and 12b.

In the present embodiment, even when the suction pump 14 provided in common sucks air out of the multiple suction caps 12, air flow can be formed in each suction cap 12 as indicated by arrow C in the first embodiment. Therefore, ink can be prevented from entering the first path 28 from, for example, a specific suction cap 12.

### Fourth Embodiment

Next, another embodiment according to the present disclosure will be described below.

In the present embodiment, a preferred form of a suction cap 12 will be described.

In the present embodiment, the cap includes: a nip portion that comes into contact with the liquid discharge head; a suction unit coupling portion coupled to the suction unit; and a liquid absorbing member disposed between the nip portion and the suction unit coupling portion. Furthermore, in the present embodiment, when the cap comes into contact with the liquid discharge head, a first space and a second space are formed, the first space being surrounded by the nip portion and the liquid absorbing member, the second space being surrounded by the liquid absorbing member and the suction unit coupling portion. Moreover, in the present embodiment, the first path is coupled to the cap, and is connected to the first space in such a way as to communicate with the first space.

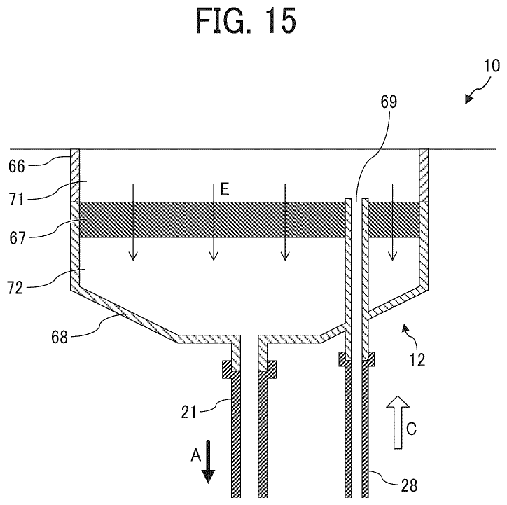

FIG. 15 is a schematic cross-sectional view of an example of the suction cap 12 in the present embodiment, and is a diagram illustrating a state in which the suction cap 12 is in contact with a liquid discharge head 10. The suction cap 12 in the present embodiment includes a nip portion 66, a suction unit coupling portion 68, and a liquid absorbing member 67. The liquid absorbing member 67 is referred also as “liquid absorber”.

The nip portion 66 comes into contact with the liquid discharge head 10. The nip portion 66 corresponds to, for example, the cap member 13 described in the first embodiment, and is, for example, a member having elasticity.

The suction unit coupling portion 68 is a portion coupled to a suction pump 14, and is coupled to, for example, a first liquid path 21.

The liquid absorbing member 67 is disposed between the nip portion 66 and the suction unit coupling portion 68. The liquid absorbing member 67 absorbs liquid discharged from the liquid discharge head 10. When suction is performed by the suction pump 14 in a state where the suction cap 12 is in contact with the liquid discharge head 10, air flows from a first path 28 to the first liquid path 21 through the liquid absorbing member 67 as indicated by arrows E in the drawing. Therefore, even if the liquid absorbing member 67 is placed, suction can be performed by the suction pump 14.

For example, an open-cell sponge or a sintered porous body can be used as the liquid absorbing member 67.

The liquid absorbing member 67 is disposed between the nip portion 66 and the suction unit coupling portion 68. As a result, it is possible to prevent the suction cap 12 from being spattered and contaminated with liquid at the time of suction.

In addition, when the suction cap 12 comes into contact with the liquid discharge head 10, a first space 71 and a second space 72 are formed as illustrated in the drawing. The first space 71 is surrounded by the nip portion 66 and the liquid absorbing member 67. The second space 72 is surrounded by the liquid absorbing member 67 and the suction unit coupling portion 68. Furthermore, the first path 28 is coupled to the suction cap 12, and is connected to the first space 71 in such a way as to communicate with the first space 71 as illustrated in the drawing. For example, a through-hole is provided in the liquid absorbing member 67, and the first path 28 is inserted into the through-hole.

The first path 28 is connected to the first space 71 at a first path connecting portion 69 in the first space 71.

The first path 28 is connected to the first space 71 in such a way as to communicate with the first space 71. As a result, when suction is performed, the first path 28 is coupled to the suction cap 12 on an upstream side in a direction in which air flows. Therefore, when suction is stopped, it becomes easier to prevented ink from entering the first path 28.

Thus, the cap (12, 12a, 12b) includes: a nip portion (66) to contact with the nozzle surface of the liquid discharge head (10, 10a, 10b); a suction unit coupling portion (68) coupled to the suction unit (14); and a liquid absorber (67) between the nip portion (66) and the suction unit coupling portion (68) in the cap (12, 12a, 12b) to separate a space in the cap (12, 12a, 12b) into: a first space (71) surrounded by the nip portion (66) and the liquid absorber (67); and a second space (72) surrounded by the liquid absorber (67) and the suction unit coupling portion (68), and the first path (28, 28a, 28b, 28c) penetrating through the suction unit coupling portion (68) and the liquid absorber (67) to communicate with the first space (71).

The suction caps 12 illustrated in FIGS. 13A, 13B, 14A, and 14B are illustrated as the suction cap 12 of the present embodiment. In the first to third embodiments above, it is preferable to use the suction cap 12 of the present embodiment, but the present disclosure is not limited to the present embodiment.

### Fifth Embodiment

Next, another embodiment according to the present disclosure will be described below.

In the present embodiment, when multiple liquid discharge heads and multiple suction caps are used, it is possible to detect whether ink has entered a first path 28 and ink adhesion has occurred. Furthermore, in the present embodiment, it is possible to detect whether ink has entered the first path 28 and ink adhesion has occurred, for each of paths corresponding to multiple suction caps 12. Therefore, the first path 28 in which ink adhesion has occurred can be determined. As a result, maintenance, repair, and the like of a maintenance apparatus can be easily performed.

A maintenance apparatus according to the present embodiment has the following characteristics.

The maintenance apparatus according to the present embodiment includes: a cap sealing member that can seal the cap; an intermediate opening and closing unit provided between the opening and closing unit and the opening port; and a pressure measurement unit that measures pressure in the first path. In addition, the cap sealing member in the present embodiment can seal multiple the caps, and the intermediate opening and closing unit includes multiple intermediate opening and closing units, the intermediate opening and closing units being provided such that there is a one-to-one correspondence between the intermediate opening and closing units and the opening ports. Furthermore, in the present embodiment, it is possible to detect whether there is an anomaly separately for the first path corresponding to each of the caps, by causing the cap sealing member to seal the caps, causing the suction unit to perform suction unit, and controlling opening and closing of the intermediate opening and closing units.

First, the present embodiment will be described with reference to FIGS. 14A and 14B. The maintenance apparatus according to the present embodiment includes a cap sealing member 60, intermediate release valves 65 (intermediate opening and closing units), and a pressure sensor 61 (pressure measurement unit).

The maintenance apparatus includes multiple intermediate release valves 65 that are referred also as “multiple intermediate valves”.

The cap sealing member 60 can seal the multiple suction caps 12. Where and how to place the cap sealing member 60 is not particularly limited, and can be appropriately selected. In FIGS. 14A and 14B, a member supporting liquid discharge heads 10 and a member supporting the cap sealing member 60 are separately provided, but the present disclosure is not limited thereto. The same member may serve as both the member supporting the liquid discharge heads 10 and the member supporting the cap sealing member 60.

The cap sealing member 60 can simultaneously seal the multiple suction caps 12. The single cap sealing member 60 may simultaneously seal the multiple suction caps 12. Alternatively, the cap sealing member 60 may be provided for each suction cap 12. The cap sealing member 60 can perform sealing by means of any contact-separation unit. The cap sealing member 60 may move toward the suction caps 12. Alternatively, the suction caps 12 may move toward the cap sealing member 60.

The intermediate release valve 65 is an example of the intermediate opening and closing unit, and can open and close a path. Each of the intermediate release valves 65 is provided for corresponding one of the multiple suction caps 12 such that intermediate release valves 65a and 65b are provided for suction caps 12a and 12b, respectively. When described without distinction, the intermediate release valves 65a and 65b are also referred to as the intermediate release valves 65 and the like.

Each intermediate release valve 65 is provided between an atmosphere release valve 16 (opening and closing unit) and a micro-opening port 18. As illustrated, the intermediate release valve 65a is provided between the atmosphere release valve 16 and a micro-opening port 18a, and the intermediate release valve 65b is provided between the atmosphere release valve 16 and a micro-opening port 18b.

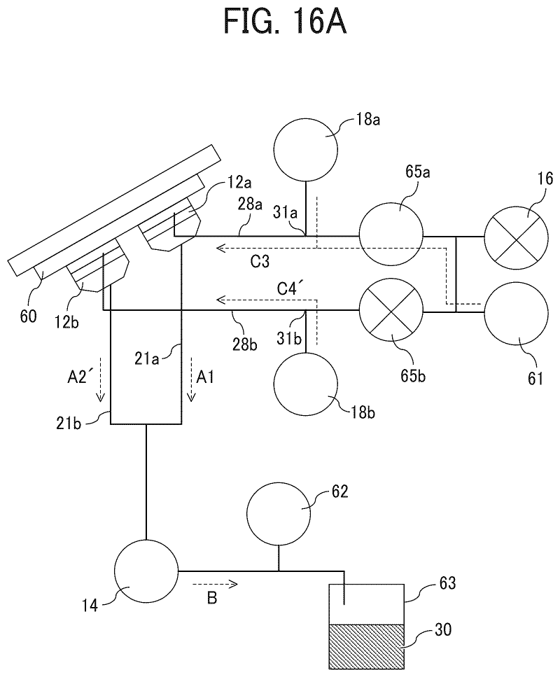

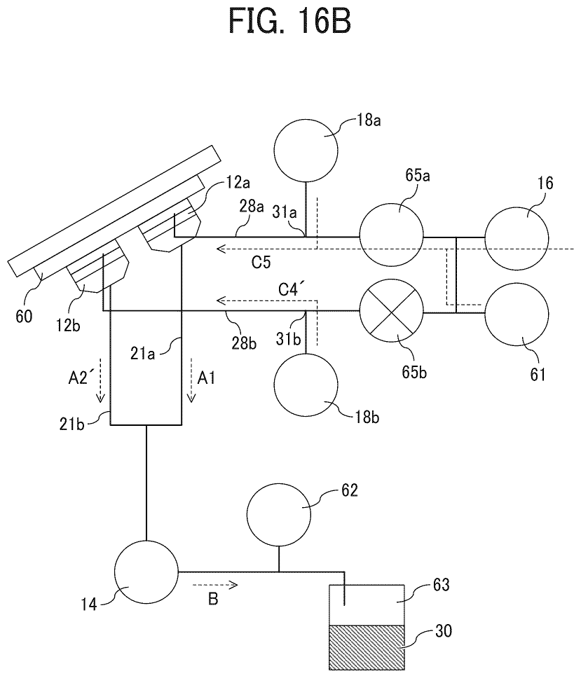

When the intermediate release valve 65 is closed, a path from the atmosphere release valve 16 to the suction cap 12 is blocked. For example, when the intermediate release valve 65a is closed, a path between the atmosphere release valve 16 and the suction cap 12a is blocked. Similarly, when the intermediate release valve 65b is closed, a path between the atmosphere release valve 16 and the suction cap 12b is blocked. As described below with reference to FIGS. 16A and 16B, each intermediate release valve 65 is provided for corresponding one of the multiple suction caps 12. As a result, it is possible to detect whether ink adhesion has occurred, for the first path 28 corresponding to each suction cap 12.

For example, in the case of detecting whether ink adhesion has occurred in a first path 28a corresponding to the suction cap 12a, the suction caps 12 are sealed by the cap sealing member 60, the atmosphere release valve 16 is closed, suction is performed by a suction pump 14, and the intermediate release valve 65 other than the intermediate release valve 65a is closed. That is, one of the intermediate release valves 65, that is, the intermediate release valve 65a, is kept open. When ink adhesion has not occurred in the first path 28a, air is sucked out of the first path 28a by the suction pump 14, and the pressure sensor 61 detects a negative pressure. When the pressure sensor 61 detects a negative pressure, it can be determined that ink adhesion has not occurred in the first path 28a.

Meanwhile, when ink adhesion has occurred in the first path 28a to block the first path 28a, the negative pressure caused by suction performed by the suction pump 14 does not reach the pressure sensor 61 due to the adhering ink. Therefore, the pressure sensor 61 does not detect the negative pressure. As a result, it can be determined that ink adhesion has occurred in the first path 28a. When the pressure sensor 61 has detected no change in pressure, it can also be determined that ink adhesion has occurred in the first path 28a.

Thus, the maintenance apparatus (11) includes: a cap sealing member (60) to seal the multiple cap (12, 12a, 12b); multiple intermediate valves (65) between the valve (16) and the multiple opening ports (18, 18a, 18b) in the multiple first paths, respectively; a sensor (61) to measure a pressure in each of the multiple first paths (28, 28a, 28b, 28c); and circuitry configure to: bring the multiple caps (12, 12a, 12b) into contact with the cap sealing member (60) to seal the multiple caps (12, 12a, 12b) with the cap sealing member (60), close the valve (16); cause the suction unit (14) to sucks the liquid from the multiple caps; open one of the 25 multiple intermediate valves (65) and close other of the multiple intermediate valves (65); and cause the sensor to measure the pressure in one the multiple first paths (28, 28a, 28b, 28c) corresponding to the one of the multiple intermediate valves (65).

In addition to the above case, it may be determined that an anomaly has occurred in, for example, a case where ultimate pressure has decreased by more than a certain amount as compared with normal times (at the time of shipment or the like), a case where ultimate pressure does not change, a case where it takes a long time for pressure to reach a certain level, and a case where pressure rapidly changes. The opening and closing of the intermediate release valve 65 is controlled in this manner. As a result, it is possible to detect, for the first path 28 corresponding to each suction cap 12, whether pressure is normal, whether an anomaly has occurred, and whether ink adhesion has occurred.

For example, an electromagnetic valve can be used as the intermediate release valve 65, as with the atmosphere release valve 16. The intermediate release valve 65 can be opened and closed by a controller 100, for example. In addition, the intermediate release valves 65a and 65b can be separately opened and closed.

The pressure sensor 61 measures pressure in the first path 28. The pressure sensor 61 is not particularly limited, and a known pressure measurement unit can be used.

FIGS. 16A and 16B are diagrams for further describing the present embodiment, and are diagrams illustrating a state in which the cap sealing member 60 seals the suction caps 12 in the example illustrated in FIG. 14A. In FIGS. 16A and 16B, illustration of the liquid discharge heads 10 is omitted.

As illustrated in FIG. 16A, the cap sealing member 60 can simultaneously seal the suction cap 12a and the suction cap 12b. FIG. 16A illustrates an example of a case where the atmosphere release valve 16 is closed, and the intermediate release valve 65b corresponding to the suction cap 12b and the micro-opening port 18b is closed. In this case, the path from the atmosphere release valve 16 and the pressure sensor 61 to the suction cap 12b is blocked.

When suction is performed by the suction pump 14 in this state, air flows in the path corresponding to the suction cap 12a as indicated by arrow C3 since the intermediate release valve 65a is open. Meanwhile, since the intermediate release valve 65b is closed, air flows in the path corresponding to the suction cap 12b as indicated by arrow C4′. If ink adhesion has occurred in a path C3 coupled to the pressure sensor 61, suction is not sufficiently performed in the path. Therefore, a change in pressure is not detected. Thus, it is possible to determine whether ink adhesion has occurred in the path C3.

Next, when suction is performed by the suction pump 14 in a state where the atmosphere release valve 16 is open as illustrated in FIG. 16B, air flows in the path corresponding to the suction cap 12a as indicated by arrow C5 since the intermediate release valve 65a and the atmosphere release valve 16 are open. If ink adhesion has occurred in a path on the atmosphere release valve 16 side (a path between the intermediate release valve 65a and the atmosphere release valve 16) corresponding to a difference between the path C3 and a path C5, the path is not opened to the atmosphere. At this time, the pressure sensor 61 detects a negative pressure having a value close to a value to be detected during normal suction. In this manner, it is also possible to determine whether ink adhesion has occurred in the path between the intermediate release valve 65 and the atmosphere release valve 16.

Similarly, the other intermediate release valve 65 is caused to switch between being opened and closed. As a result, it is also possible to determine whether ink adhesion has occurred in a path corresponding to the other suction cap 12. Therefore, it is also possible to determine whether ink adhesion has occurred, by causing the intermediate release valves 65 to switch between being opened and closed.

A pressure sensor 62 is provided downstream of the suction pump 14 (on a waste liquid tank 63 side). The pressure sensor 62 can be used to detect whether ink adhesion has occurred in a path downstream of the suction pump 14.

In the present embodiment, the suction caps 12 are sealed with the cap sealing member 60, the opening and closing of the intermediate release valves 65 is controlled, so that it is possible to detect, for each suction cap 12, whether pressure in the first path 28 is normal and whether an anomaly has occurred. Therefore, according to the present embodiment, suction is performed while the intermediate release valve 65 of each suction cap 12 is selectively opened and closed. As a result, even when ink enters the first path 28 and ink adhesion has occurred in the path, it is possible to check pressure in the path for each suction cap 12 and detect a failure.

As in the present embodiment, the pressure sensor 61 (pressure measurement unit) is preferably provided between the atmosphere release valve 16 and the multiple intermediate release valves 65 and used in common for the multiple suction caps 12. As a result of using the pressure sensor 61 in common, it is not necessary to increase the number of pressure sensors 61. Therefore, an increase in cost can be prevented.

### Sixth Embodiment

Next, another embodiment according to the present disclosure will be described below.

In the present embodiment, a preferred form of a first path 28 will be described.

The inside of the first path 28 preferably has wettability and an inner diameter that enable a meniscus to be formed by liquid (for example, ink) discharged by a liquid discharge head 10. In this case, even when, for example, ink unexpectedly drips from the liquid discharge head 10 and enters the first path 28, the ink can be discharged from the first path 28 during normal use. As a result of meniscus formation by ink in the first path 28, ink can be discharged toward the suction cap 12 by the flow of air when normal suction is performed.

A method in which the material of the first path 28 is appropriately selected to adjust wettability can be cited as an example of a method for achieving wettability that allows liquid to form a meniscus in the first path 28. The material of the first path 28 is preferably, for example, a fluorine material. In addition, the inner diameter of the first path 28 is preferably, for example, 1 mm or more and 2 mm or less. From the viewpoint of ease of forming a meniscus, it is particularly preferable to use, as the first path 28, a fluorine tube with an inner diameter of 1 mm or more and 2 mm or less.

A meniscus refers to a liquid bridge between objects. Whether ink has formed a meniscus in the first path 28 can be determined based on whether ink can be discharged when suction is performed by a pump. A suction pump 14 may be put into operation to check whether a meniscus has been formed in the first path 28, in a state where a maintenance apparatus has been formed. Alternatively, air may be sucked out of the first path 28 independently by a pump to check whether a meniscus has been formed, in a state where no maintenance apparatus has been formed.

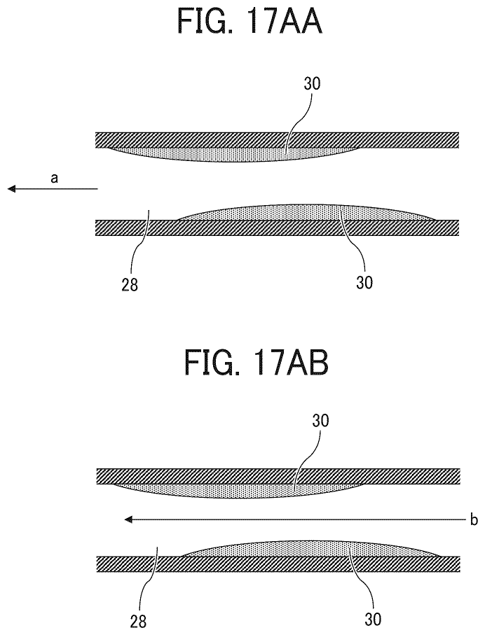

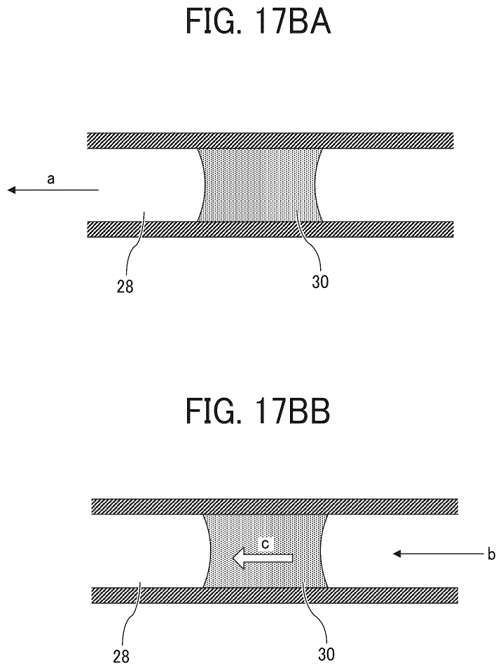

The meniscus of liquid in the first path 28 will be described with reference to FIGS. 17AA, 17AB, 17BA and 17BB. FIGS. 17AA and 17AB illustrates an example of a case where liquid does not form a meniscus inside the first path 28, and illustrates an example of a case where the first path 28 is formed of a tube having high wettability. FIGS. 17BA and 17BB illustrates an example of a case where liquid forms a meniscus inside the first path 28, and illustrates an example of a case where the first path 28 is formed of a tube having low wettability.

In FIG. 17AA, suction is performed by a pump, and arrow “a” schematically indicates the start of suction by the pump. However, as illustrated in FIG. 17AB, when ink 30 does not form a meniscus on an inner surface of the tube, suction performed by the pump results in discharge of air alone. Arrow “b” schematically indicates the flow of air. Therefore, when the ink 30 enters the first path 28 and forms no meniscus on the inner surface of the tube, the ink 30 is less likely to be discharged even if suction is performed.

Similarly, in FIG. 17BA, suction is performed by the pump, and arrow “a” schematically indicates the start of suction by the pump. As illustrated in of FIG. 17BB, in a case where the ink 30 forms a meniscus on the inner surface of the tube, the ink 30 is discharged (arrow “c”) together with air (arrow “b”) when sucked by the pump. As a result of meniscus formation by target liquid on the inner surface of the first path 28 in this manner, even if liquid enters the first path 28, the liquid having entered the first path 28 can be discharged during normal use.

Aspects of the present disclosure are, for example, as follows.

### Aspect 1

According to Aspect 1, a maintenance apparatus includes:
a cap that can be brought into contact with a nozzle surface of a liquid discharge head;
a suction unit that is coupled to the cap and sucks air out of the cap;
an opening and closing unit that is coupled to the cap by a first path, and causes the first path to be opened and closed to an atmosphere;
the first path coupling the cap and the opening and closing unit; and
an opening port that causes the first path to communicate with the atmosphere.

### Aspect 2

According to Aspect 2, in the maintenance apparatus of Aspect 1,
the opening port includes an open hole forming member, an open hole communicating with the atmosphere being formed in the open hole forming member, and
the open hole forming member is coupled to the first path by a second path that is a branch of the first path.

### Aspect 3

According to Aspect 3, in the maintenance apparatus of Aspect 2,
the open hole forming member is an inelastic member.

### Aspect 4

According to Aspect 4, in the maintenance apparatus of Aspect 2,
the first path is coupled to the second path at a coupling point, the coupling point on the first path being located closer to the opening and closing unit than to the cap, a distance from the coupling point to the opening and closing unit being equal to or less than ½, assuming that a distance along the first path from the cap to the opening and closing unit is 1.

### Aspect 5

According to Aspect 5, in the maintenance apparatus of Aspect 1,
the opening port is a hole formed in the first path.

### Aspect 6

According to Aspect 6, in the maintenance apparatus of Aspect 5,
on the first path, the opening port is located closer to the opening and closing unit than to the cap, a distance from the opening port to the opening and closing unit being equal to or less than ½, assuming that a distance along the first path from the cap to the opening and closing unit is 1.

### Aspect 7

According to Aspect 7, in the maintenance apparatus of any one of Aspects 1 to 6,
the suction unit is a diaphragm pump.

### Aspect 8

According to Aspect 8, in the maintenance apparatus of any one of Aspects 1 to 7,
the opening and closing unit is an electromagnetic valve.

### Aspect 9

According to Aspect 9, in the maintenance apparatus of any one of Aspects 1 to 8,
a part of the first path is located above a point where the first path is coupled to the opening and closing unit, in a vertical direction.

### Aspect 10

According to Aspect 10, in the maintenance apparatus of any one of Aspects 1 to 9,
a part of the first path is located above a level on which the cap comes into contact with the nozzle surface of the liquid discharge head, in a vertical direction.

### Aspect 11

According to Aspect 11, in the maintenance apparatus of Aspect 1, 4, 7, 8, 9, or 10,
the first path has a second path that is a branch of the first path,
the second path has a hole at an end opposite to the first path, and
the opening port is the hole.

### Aspect 12

According to Aspect 12, in the maintenance apparatus of any one of Aspects 1 to 11,
the liquid discharge head includes multiple liquid discharge heads,
the cap and the opening port include multiple caps and multiple opening ports, respectively,
each of the opening ports is provided for corresponding one of the multiple caps, and
the suction unit and the opening and closing unit are common to the multiple caps, so that the suction unit is coupled to the multiple caps, and sucks air out of the multiple caps.

### Aspect 13

According to Aspect 13, the maintenance apparatus of Aspect 12 further includes:
a cap sealing member that can seal the cap; an intermediate opening and closing unit provided between the opening and closing unit and the opening port; and a pressure measurement unit that measures pressure in the first path,
in which the cap sealing member can seal the multiple caps,
the intermediate opening and closing unit includes multiple intermediate opening and closing units, the intermediate opening and closing units being provided such that there is a one-to-one correspondence between the intermediate opening and closing units and the opening ports, and
it is possible to detect whether there is an anomaly separately for the first path corresponding to each of the caps, by causing the cap sealing member to seal the caps, causing the suction unit to perform suction, and controlling opening and closing of the intermediate opening and closing units.

### Aspect 14

According to Aspect 14, in the maintenance apparatus of any one of Aspects 1 to 13,
the cap includes: a nip portion that comes into contact with the liquid discharge head; a suction unit coupling portion coupled to the suction unit; and a liquid absorbing member disposed between the nip portion and the suction unit coupling portion,
a first space and a second space are formed as a result of the cap coming into contact with the liquid discharge head, the first space being surrounded by the nip portion and the liquid absorbing member, the second space being surrounded by the liquid absorbing member and the suction unit coupling portion, and
the first path is coupled to the cap, and is connected to the first space in such a way as to communicate with the first space.

### Aspect 15

According to Aspect 15, in the maintenance apparatus of any one of Aspects 1 to 14,
an inside of the first path has wettability and an inner diameter that enable a meniscus to be formed by liquid discharged by the liquid discharge head.

### Aspect 16

According to Aspect 16, a liquid discharge apparatus includes
a liquid discharge head; and
the maintenance apparatus of any one of Aspects 1 to 15.

### Aspect 17

According to Aspect 17, in the liquid discharge apparatus of Aspect 16,
the liquid discharge head is a line head-type liquid discharge head.

### Aspect 18

According to Aspect 18, the liquid discharge apparatus of Aspect 16 or 17 further includes:
a conveyor in a drum shape, the conveyor facing the liquid discharge head,
in which the liquid discharge head discharges liquid onto a recording medium being conveyed by the conveyor.

### Aspect 19

According to Aspect 19, the liquid discharge apparatus of any one of Aspects 16 to 18 further includes:
a controller,
in which when a series of actions of coming into contact with the nozzle surface, performing suction, and then moving away from the nozzle surface is defined as a single unit of cleaning operation, the series of actions being performed by the cap,
the controller performs control in such a way as to cause the suction unit to repeat operation and non-operation multiple times in the single unit of cleaning operation.

### Aspect 20

According to Aspect 20, in the liquid discharge apparatus of Aspect 19,
the controller performs control in such a way as to cause the suction unit to repeat operation and non-operation multiple times in a state where the opening and closing unit is closed in the single unit of cleaning operation, and then to open the opening and closing unit.

### Aspect 21

According to Aspect 21, a maintenance method to be performed by the maintenance apparatus of any one of Aspects 1 to 15 includes:
a cleaning step of bringing the cap into contact with the nozzle surface of the liquid discharge head, closing the opening and closing unit, and causing the suction unit to operate.

The above description is an example, and the present embodiment has unique effects for each of the following aspects.

Each of the functions of the described embodiments such as the controller 100 may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

Numerous additional modifications and variations are possible in light of the above teachings. It is therefore to be understood that, within the scope of the above teachings, the present disclosure may be practiced otherwise than as specifically described herein. With some embodiments having thus been described, it is obvious that the same may be varied in many ways. Such variations are not to be regarded as a departure from the scope of the present disclosure and appended claims, and all such modifications are intended to be included within the scope of the present disclosure and appended claims.

1. A maintenance apparatus comprising:
a cap contactable with a nozzle surface of a liquid discharge head;
a suction unit coupled to the cap to suck a liquid in the cap;
a valve coupled to the cap with a first path, the valve to cause the first path to be opened and closed to an atmosphere;
a second path branched from the first path; and
an opening port coupled to the second path and communicating with the atmosphere.

2. The maintenance apparatus according to claim 1,
wherein the opening port includes an open hole forming member having an open hole communicating with the atmosphere.

3. The maintenance apparatus according to claim 2,
wherein the open hole forming member is an inelastic member.

4. The maintenance apparatus according to claim 2,
wherein the second path is branched from the first path at a branching point,
a length of the first path from the branching point to the valve is less than a half of a length of the first path from the cap to the valve.

5. A maintenance apparatus comprising:
a cap contactable with a nozzle surface of a liquid discharge head;
a suction unit coupled to the cap to suck a liquid in the cap;
a valve coupled to the cap with a first path, the valve to cause the first path to be opened and closed to an atmosphere; and
an opening port having a hole in the first path communicating with the atmosphere.

6. The maintenance apparatus according to claim 5,
wherein a length of the first path from the hole to the valve is less than a half of a length of the first path from the cap to the valve.

7. The maintenance apparatus according to claim 1,
wherein the suction unit is a diaphragm pump.

8. The maintenance apparatus according to claim 1,
wherein the valve is an electromagnetic valve.

9. The maintenance apparatus according to claim 1,
wherein the second path is branched from the first path at a branching point,
a part of the first path is above the branching point in a vertical direction.

10. The maintenance apparatus according to claim 9,
wherein the cap contacts the nozzle surface of a liquid discharge head at a contact position in the vertical direction, and
the part of the first path is above the contact position in the vertical direction.

11. The maintenance apparatus according to claim 1,
wherein the opening port has a hole communicating with the atmosphere.

12. The maintenance apparatus according to claim 1, further comprising:
multiple caps including the cap; and
multiple opening ports including the opening port, the multiple opening ports coupled to the multiple caps with multiple second paths including the second path, respectively,
wherein the suction unit is coupled to each of the multiple caps,
the valve is coupled to each of the multiple caps with multiple first paths including the first path, and
the suction unit sucks the liquid in each of the multiple caps.

13. The maintenance apparatus according to claim 12, further comprising:
a cap sealing member to seal the multiple caps;
multiple intermediate valves between the valve and the multiple opening ports in the multiple first paths, respectively;
a sensor to measure a pressure in each of the multiple first paths; and
circuitry configure to:
bring the multiple caps into contact with the cap sealing member to seal the multiple caps with the cap sealing member,
close the valve;
cause the suction unit to suck the liquid from the multiple caps;
open one of the multiple intermediate valves and close other of the multiple intermediate valves; and
cause the sensor to measure the pressure in one the multiple first paths corresponding to the one of the multiple intermediate valves.

14. The maintenance apparatus according to claim 1,
wherein the cap includes:
a nip portion to contact with the nozzle surface of the liquid discharge head;
a suction unit coupling portion coupled to the suction unit; and
a liquid absorber between the nip portion and the suction unit coupling portion in the cap to separate a space in the cap into:
a first space surrounded by the nip portion and the liquid absorber; and
a second space surrounded by the liquid absorber and the suction unit coupling portion, and
the first path penetrating through the suction unit coupling portion and the liquid absorber to communicate with the first space.

15. A liquid discharge apparatus comprising:
a liquid discharge head to discharge a liquid onto a medium; and
the maintenance apparatus according to claim 1 to maintain the liquid discharge head.

16. The liquid discharge apparatus according to claim 15,
wherein the liquid discharge head is a line head-type liquid discharge head.

17. The liquid discharge apparatus according to claim 15, further comprising:
a drum conveyor facing the liquid discharge head to convey the medium to a position facing the liquid discharge head.

18. The liquid discharge apparatus according to claim 15, further comprising:
circuitry configured to:
bring the cap into contact with the nozzle surface of the liquid discharge head; and
cause the suction unit to repeatedly perform:
sucking the liquid from the cap; and
temporarily stop sucking the liquid from the cap,
for multiple times while the cap contacting the nozzle surface.

19. The liquid discharge apparatus according to claim 18,
wherein the circuitry is further configured to:
bring the cap into contact with the nozzle surface of the liquid discharge head;
close the valve;
cause the suction unit to repeatedly perform:
sucking the liquid from the cap; and
temporarily stop sucking the liquid from the cap,
for multiple times while the cap contacts the nozzle surface and the valve is closed as a sucking operation; and
open the valve after the sucking operation of the suction unit.

20. A maintenance method comprising:
causing a cap to contact with a nozzle surface of a liquid discharge head;
closing a valve coupled to the cap with a first path; and
sucking a liquid in the cap while air is supplied to the cap from an opening port coupled to a second path communicating with an atmosphere, the second path branched from the first path.
